(19) United States
(12) Patent Application Publication
(10) Pub. No.: US 2008/0117880 A1
(43) Pub. Date: May 22, 2008

(54) ACCESS POINT AND CHANNEL SWITCHING METHOD THEREOF

(75) Inventors: Chi-Ming Lu, Tu-Cheng (TW); Chin-Lung Ho, Tu-Cheng (TW)

Correspondence Address: PCE INDUSTRY, INC.;ATT. CHENG-JU CHIANG, 458 E. LAMBERT ROAD, FULLERTON, CA, 92835, US

(73) Assignee: HON HAI PRECISION INDUSTRY CO., LTD., Tu-Cheng (TW)

(21) Appl. No.: 11/940,329

(22) Filed: Nov. 15, 2007

(30) Foreign Application Priority Data
Nov. 17, 2006 (TW) 95142694

(51) Int. Cl. H04Q 7/00

(52) U.S. Cl. 370/333

(57) ABSTRACT

An access point (AP) (20A) for automatically switching channels includes a transceiving module (201), a channel quality evaluation module (207) and a channel switching module (209). The transceiving module is provided for communicating with another AP (20B). The channel quality evaluation module is provided for evaluating quality of the communication channels between the APs, generating an evaluation result comprising communication channels with different transmission qualities, and selecting a channel with best quality as communication channel between the APs. The channel switching module is provided for selecting a channel with best quality and switching the current communication channel to the channel with best quality. A method for automatically switching channels applied between two APs is also provided in the present invention to avoid interferences appearing in the signal transmission process without manual operation.

### BACKGROUND OF THE INVENTION

1. Field of the Invention

The present invention relates to wireless network devices, and particularly to an access point and a method for switching channels thereof.

2. Description of Related Art

Wireless access points (AP) are commonly used for information transmission in the existing digital home network. One of the common wireless topologies includes two APs wirelessly connected together and communicating with each other over radio channels. In practical applications, the radio channels used by two APs are prone to be interference caused by radio signals transmitted from other electronic devices, such as a microwave oven, which can lower the transmission quality between the two APs.

A conventional way to avoid the interference is switching the radio channels from one currently used to another. Nevertheless, switching channels between the two APs is usually performed manually, which is rather inconvenient. Besides, coordination between two APs is also very important during channel switching because disconnection between the APs may happen when the APs cannot successfully communicate and coordinate with each other. Therefore, automatic switching of channels between the APs based on well coordination to improve transmission quality is desired.

### SUMMARY OF THE INVENTION

One aspect of the present invention provides an access point (AP) that is adapted for communicating with another AP. The AP includes a transceiving module, a channel quality evaluation module, and a channel switching module. The transceiving module is provided for communicating with another AP. The channel quality evaluation module is provided for evaluating quality of the communication channels between the APs, generating an evaluation result comprising communication channels with different transmission qualities, and selecting a channel with best quality between the APs. The channel switching module is provided for selecting a channel with best quality and switching the current communication channel to the channel with best quality.

Another aspect of the present invention provides a method for automatic switching of channels between two APs.

Other advantages and novel features of the present invention will be drawn from the following detailed description of a preferred embodiment and a preferred method with the attached drawings, in which:

### BRIEF DESCRIPTION OF THE DRAWINGS

FIG. 1 is a schematic diagram of an application environment of an exemplary embodiment of the present invention;

FIG. 2 is a schematic diagram of functional modules of an access point (AP) of FIG. 1;

FIG. 3 is a schematic diagram of functional modules of another AP of FIG. 1;

FIG. 4 is a flowchart of a method for switching channels in accordance with another exemplary embodiment of the present invention; and

FIG. 5 is a detailed flowchart of FIG. 4.

### DETAILED DESCRIPTION OF THE INVENTION

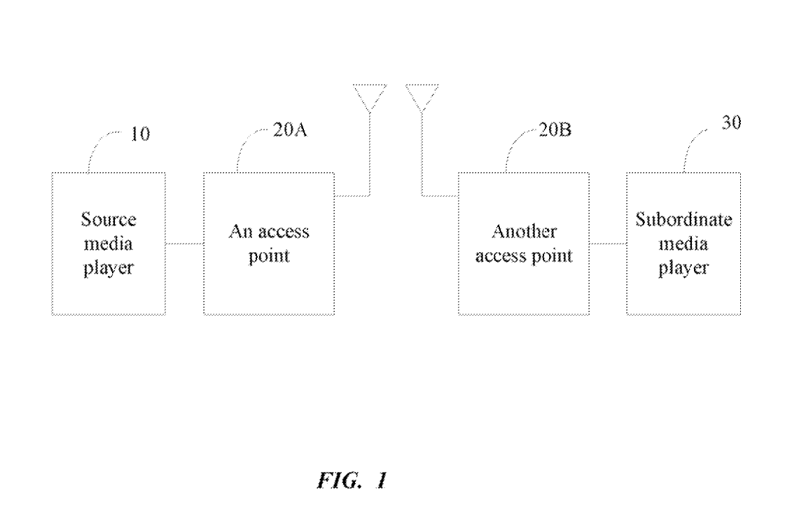

FIG. 1 is a schematic diagram of an application environment of an exemplary embodiment of the present invention.

A source media player 10 is connected to an access point (AP) 20A through a cable. Another AP 20B is connected to a subordinate media player 30 through a cable. The APs 20A and 20B communicate with each other over radio channels. In this embodiment, the AP 20A and the AP 20B are homogeneous. The data played by both the source media player 10 and the subordinate media player 30, are multimedia data streams.

In other embodiments, the AP 20A and the AP 20B may be mobile terminals (MTs).

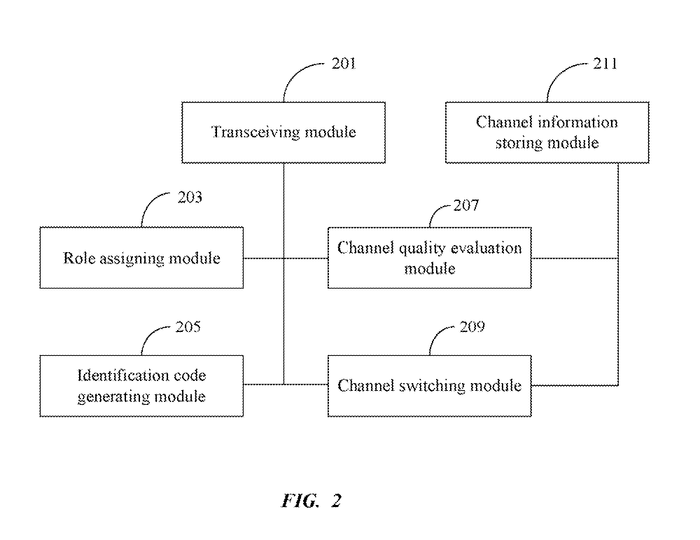

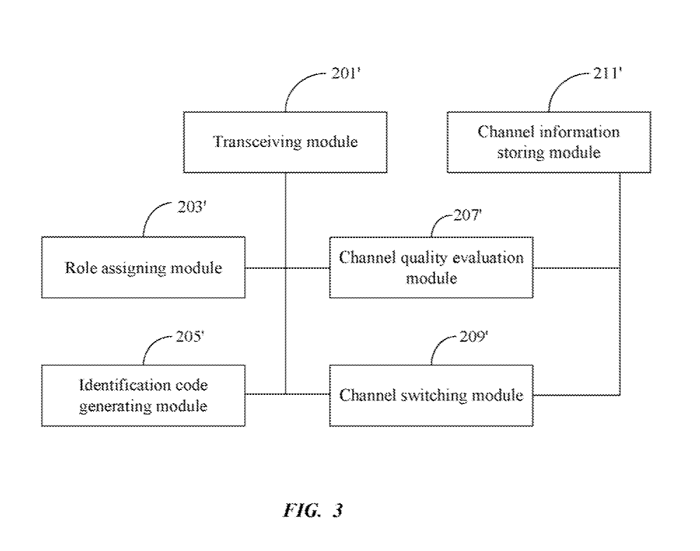

FIG. 2 is a schematic diagram illustrating functional modules of the AP 20A of the exemplary embodiment of the present invention. FIG. 3 is a schematic diagram of functional modules of the AP 20B of the exemplary embodiment of the present invention.

The AP 20A includes a transceiving module 201, a role assigning module 203, an identification code generating module 205, a channel quality evaluation module 207, a channel switching module 209, and a channel information storing module 211. The AP 20B similarly includes a transceiving module 201′, a role assigning module 203′, an identification code generating module 205′, a channel quality evaluation module 207′, a channel switching module 209′, and a channel information storing module 211′. The functional modules of the AP 20A are the same as those of the AP 20B. For simplicity, only the functional modules of the AP 20A are disclosed hereinafter.

The transceiving module 201 is provided for communicating with the AP 20B.

The role assigning module 203 is provided for assigning the roles to the AP 20A and the AP 20B. In this embodiment, the role of the AP 20A may be an initiator or cooperator AP. If the AP 20A were the initiator AP, then the AP 20B would be the cooperator AP, or vice versa.

The identification code generating module 205 is provided for randomly generating identification codes based on the role of the AP 20A. The identification codes are stored in the channel information storing module 211 and transmitted to the AP 20B via the transceiving module 201. In this embodiment, the identification codes include the identification codes of the initiator AP and the cooperator AP.

The channel quality evaluation module 207 is provided for assessing available communication channels between the APs 20A and 20B, and generating an evaluation result comprising quality information on the communication channels, and then selecting a communication channel with best quality.

The channel switching module 209 is provided for switching from a current communication channel to the channel with the best quality after receiving a channel switching response from the AP 20B.

The channel information storing module 211 is provided for storing quality information on all the available communication channels between the APs 20A and 20B.

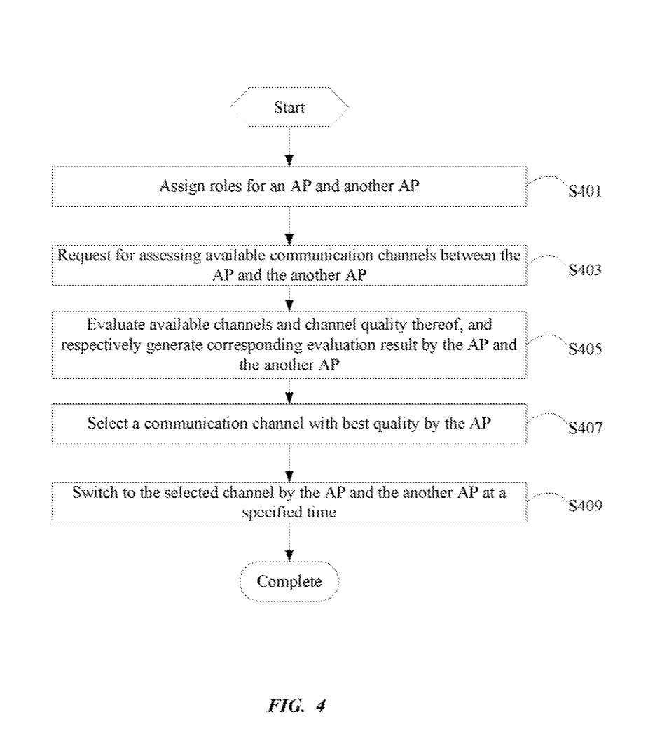

FIG. 4 is a flowchart of a method for switching channels in accordance with an exemplary embodiment of the present invention.

In step S401, the role assigning module 203 assigns roles for a AP 20A and another AP 20B. The AP 20A requests the AP 20B to assign the AP 20A as the initiator AP and assign the AP 20B as the cooperator AP. The AP 20B responds to the AP 20A to acknowledge the request, then the AP 20A assigns the roles of initiator AP and cooperator AP as agreed. In this embodiment, the AP 20A is assigned to be the initiator AP and the AP 20B is assigned to be the cooperator AP. In other embodiments, the AP 20A may be assigned to be the cooperator AP while the AP 20B may be assigned to be the initiator AP. In this embodiment, both the request and response for assigning roles are based on the User Datagram Protocol (UDP).

In step S403, the identification generating module 205 randomly generates identification codes for the initiator AP 20A, and requests for assessment of communication channels between the initiator AP 20A and the cooperator AP 20B. In this embodiment, the initiator AP 20A requests the cooperator AP 20B to assess channels, the cooperator AP 20B then responds to the initiator AP 20A to acknowledge the request. Both the request to assess channels and the response are based on the Transmission Control Protocol (TCP).

In step S405, the channel quality evaluation module 207 evaluates quality of the available communication channels and generates corresponding evaluation results. In this embodiment, the initiator AP 20A and the cooperator AP 20B both evaluate the available communication channels, and respectively generate evaluation results comprising communication channels with different transmission qualities. In this embodiment, the evaluation result of the initiator AP 20A is stored in the channel information storing module 201, the evaluation result of the cooperator AP 20B is stored in the channel information storing module 211′.

In step S407, the channel quality evaluation module 207 selects a channel with the best quality based on the channel evaluation results of the initiator AP 20A and cooperator AP 20B. In this embodiment, the initiator AP 20A requests the cooperator AP 20B to provide the evaluation result thereof, the cooperator AP 20B responds to the request and transmits the evaluation results thereof to the initiator AP 20A, then the initiator AP 20A selects the channel with the best quality.

In step S409, the initiator AP 20A and the cooperator AP 20B switch to the selected channel at a specified time. In this embodiment, the initiator AP 20A requests the cooperator AP 20B to switch from the current communication channel to the selected channel at a specified time. The cooperator AP 20B responds to the initiator AP 20A to acknowledge the request. The initiator AP 20A and the cooperator AP 20B then switch to the selected channel at the specified time. In this embodiment, the request for switching channel, which includes the selected channel along with the time specified by the initiator AP 20A, and the response from the cooperator AP 20B are also based on the TCP.

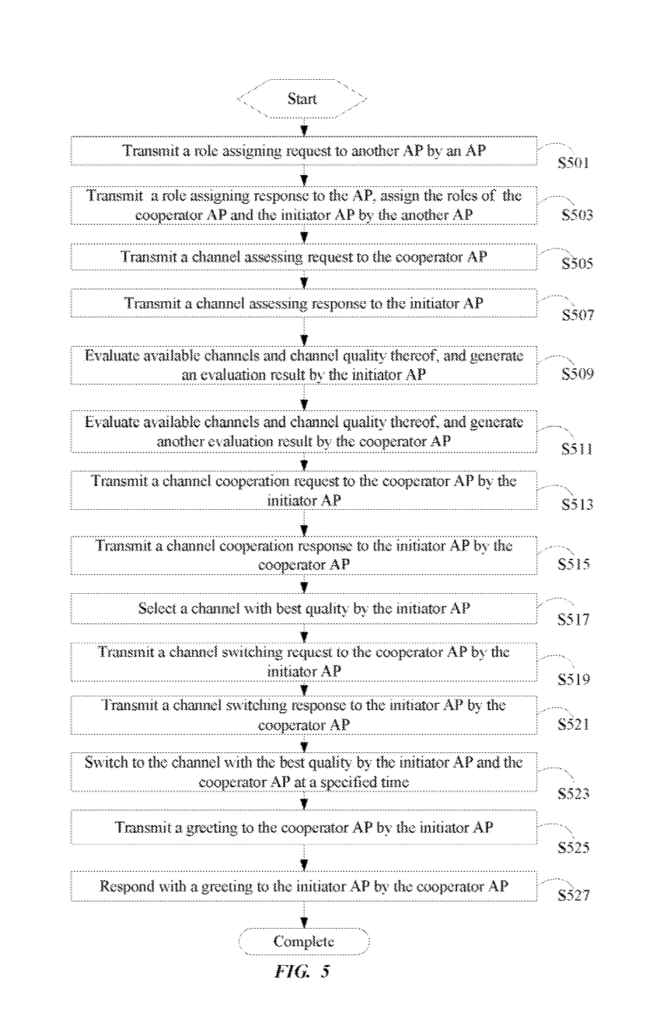

FIG. 5 is a detailed description of the method of FIG. 4.

In step S501, An AP 20A transmits a role assigning request to another AP 20B. In this embodiment, the role assigning request is generated via the role assigning module 203 and transmitted to the AP 20B via the transceiving module 201. The role assigning request, which includes the request for assigning the AP 20A to be the initiator AP and assigning the AP 20B to be the cooperator AP, is a UDP packet.

In step S503, the AP 20B transmits a role assigning response to the AP 20A to acknowledge the role assigning request. In this embodiment, the AP 20B receives the role assigning request via the transceiving module 201′, generates the role assigning response via the role assigning module 203′, and then transmits the role assigning request response to the AP 20A via the transceiving module 201′ to acknowledge the role assigning request. The role assigning response is also a UDP packet.

In step S505, the initiator AP 20A transmits a channel assessing request to the cooperator AP 20B. In this embodiment, the channel assessing request includes the identification codes of the initiator AP 20A, which are generated by the initiator AP 20A via the identification code generating module 205 and transmitted to the cooperator AP 20B via the transceiving module 201. The channel assessing request is a TCP packet.

In step S507, The cooperator AP 20B transmits a channel assessing response to the initiator AP 20A to acknowledge the channel assessing request. In this embodiment, the channel assessing response includes the identification codes of the cooperator AP 20B, which are generated by the cooperator AP 20B via the identification code generating module 205′ and transmitted to the initiator AP 20A via the transceiving module 201′. The channel assessing response is also a TCP packet.

In step S509, the channel quality evaluation module 207 of the initiator AP 20A evaluates the quality of the available communication channels then generates an evaluation result comprising communication channels with different transmission qualities, which will be stored in the channel information storing module 211.

In step S511, in this embodiment, the channel quality evaluation module 207′ of the initiator AP 20B evaluates the quality of the available communication channels then generates an evaluation result comprising communication channels with different transmission qualities, which will be stored in the channel information storing module 211′.

In step S513, the initiator AP 20A transmits a channel cooperation request to the cooperator AP 20B. In this embodiment, the channel cooperation request is generated via the channel quality evaluation module 207 and transmitted to the cooperator AP 20B via the transceiving module 201 to request the cooperator AP 20B transmit the evaluation result thereof. In this embodiment, the channel cooperation request is a TCP packet.

In step S515, the cooperator AP 20B transmits a channel cooperation response to the initiator AP 20A to acknowledge the channel cooperation request. In this embodiment, the channel cooperation response, which includes the evaluation result of the cooperator AP 20B, is generated via the channel quality evaluation module 207′ and transmitted to the initiator AP 20A via the transceiving module 201′. In this embodiment, the channel selection response is also a TCP packet.

In step S517, the initiator AP 20A selects a channel with the best quality. In this embodiment, the channel quality evaluation module 209 selects the channel with the best quality based on the evaluation results thereof and the response from the cooperator AP 20B.

In step S519, the initiator AP 20A transmits a channel switching request to the cooperator AP 20B for switching from the current communication channel to the channel with the best quality. In this embodiment, the channel switching module 209 generates the channel switching request based on the selected channel. The channel switching request, which includes the channel with the best quality and a specified time for switching to the channel, is also a TCP packet.

In step S521, the cooperator AP 20B transmits a channel switching response to the initiator AP 20A to acknowledge the channel switching request. In this embodiment, the channel switching response, which is generated via the channel switching module 209′ and transmitted to the initiator AP 20A via the transceiving module 201′, is also a TCP packet.

In step S523, the initiator AP 20A and the cooperator AP 20B switch to the channel with the best quality at the specified time.

In step S525, the initiator AP 20A transmits a greeting to the cooperator AP 20B via the switched channel. In this embodiment, the greeting, such as a hello message, is generated via the channel quality evaluation module 207 and transmitted to the cooperator AP 20B via the transceiving module 201.

In step S527, the cooperator AP 20B responds with a greeting to the initiator AP 20A via the switched channel. In this embodiment, the greeting, such as a hello message, is generated via the channel quality evaluation module 207′ and transmitted to the initiator AP 20A via the transceiving module 201′.

In any of the above-described exemplary embodiments, the APs 20A and 20B can automatically switch wireless communication channels therebetween.

Although the features and elements of the present invention are described in the exemplary embodiment in particular combinations, each feature or element can be used alone or in various within the principles of the invention to the full extent indicated by the broad general meaning of the terms in which the appended claims are expressed.

What is claimed is:

1. An access point (AP) adapted for communicating with another AP, the AP comprising:
a transceiving module for communicating with the another AP;
a channel quality evaluation module for evaluating communication qualities of the communication channels between the AP and the another AP, generating an evaluation result comprising communication channels with different transmission qualities, and selecting a channel with best quality as communication channel between the AP and the another AP; and
a channel switching module for switching the current communication channel to the channel with best quality.

2. The AP of claim 1, further comprising a role assigning module for assigning a role to the AP.

3. The AP of claim 2, wherein the role of the AP comprises an initiator AP role and a cooperator AP role.

4. The AP of claim 3, further comprising an identification code generating module for randomly generating identification codes based on the role of the AP.

5. The AP of claim 4, further comprising a channel information storing module for storing the identification codes of the AP and the another AP.

6. The AP of claim 1, Wherein the AP and the another AP are wireless APs.

7. A method for automatically switching communication channels between two access points (APs), the method comprising the steps of:
requesting assessment of available communication channels from one of the APs to the other;
evaluating respectively by the two APs the qualities of available communication channels therebetween;
selecting a communication channel with best quality from the communication channels evaluated by the two APs; and
switching the current communication channel to the channel with best quality.

8. The method of claim 7, further comprising the steps of:
requesting assigning roles from one of the APs to the other;
assigning one of the APs as an initiator AP and the other AP as a cooperator AP; and
generating identification codes for each AP based on the assigned roles.

9. The method of claim 8, wherein the requesting step further comprises:
requesting for assessing channels from the initiator AP to the cooperator AP;
responding for assessing channels from the cooperator AP to the initiator AP.

10. The method of claim 9, wherein the request for assessing channels includes the identification codes of the initiator AP, and the response for assessing channels includes the identification codes of the cooperator AP.

11. The method of claim 8, wherein the evaluating step comprises:
evaluating the qualities of the communication channels between the initiator AP and the cooperator AP;
respectively generating an evaluation result by the initiator AP and the cooperator AP.

12. The method of claim 11, wherein the selecting step comprises:
requesting for the evaluation result of the cooperator AP 20B by the initiator AP;
responding with the evaluation result to the initiator AP by the cooperator AP;
selecting the channel with best quality based on the evaluation result of the initiator AP and the response from the cooperator AP by the initiator AP.

13. The method of claim 8, wherein the switching step comprises:
requesting for switching to the channel with best quality based on the selected channel by the initiator AP;
responding for acknowledgement to switch to the channel with best quality selected by the cooperator AP;
switching to the channel with best quality by the initiator AP and the cooperator AP at a specified time.

14. The method of claim 8, further comprising the steps of:
transmitting a greeting to the cooperator AP via the channel with best quality by the initiator AP;
transmitting a greeting to the initiator AP via the switched channel by the cooperator AP.

15. A method for automatically switching communication channels between two access points (APs), the method comprising the steps of:
specifying one of the two APs as an initiator AP, and the other one as a cooperator AP;
requesting for assessing available communication channels from the initiator AP to the cooperator AP;
evaluating by at least one of the initiator AP and the cooperator AP the qualities of all communication channels between the initiator AP and the cooperator AP;
picking a communication channel with best quality from the communication channels evaluated by the initiator AP and the cooperator AP; and
switching the current communication channel to the channel with best quality.

16. The method of claim 15, wherein the qualities of all communication channels between the initiator AP and the cooperator AP are evaluated respectively by the initiator AP and the cooperator AP.

17. The method of claim 15, wherein the specifying step is based on the User Datagram Protocol (UDP); the evaluating step, picking step and switching step are all based on the Transmission Control Protocol (TCP).

18. The method of claim 15, further comprising the steps of:
sending a channel change time request from the initiator AP to the cooperator AP;
confirming a specified time at which the cooperator AP and initiator AP change to the channel with best quality by the cooperator AP.

19. The method of claim 15, further comprising the steps of:
sending a hello message from the initiator AP to the cooperator AP after switching to the channel with best quality; and
sending a response message from the cooperator AP to the initiator AP after receiving the hello message.
